(19) United States
(12) Patent Application Publication
(10) Pub. No.: US 2025/0147807 A1
(43) Pub. Date: May 8, 2025

(54) OPTIMIZATION RESOURCE ALLOCATION OF SOFTWARE AS A SERVICE (SAAS) SYSTEM

(71) Applicant: SAP SE, Walldorf (DE)

(72) Inventor: HUI LI, Shanghai (CN)

(21) Appl. No.: 18/387,703

(22) Filed: Nov. 7, 2023

(51) Int. Cl. G06F 9/50

(52) U.S. Cl. CPC G06F 9/5027; G06F 9/5016

(57) ABSTRACT

Embodiments are described for a resource analysis system comprising a memory and at least one processor coupled to the memory. The at least one processor is configured to receive history data of one or more data processes and determine an average central processing unit (CPU) resource and an average memory resource of a data process of the one or more data processes based on the history data. The at least one processor is further configured to determine a resource type of the data process based on the average CPU resource and the average memory resource and transmit a resource type report to a resource record server, wherein the resource type report indicates the resource type of the data process and the data process.

### BACKGROUND

Cloud computing services, such as software as a service (SaaS), provide software applications over the Internet. The cloud computing services are supported by servers that are located remotely with various capabilities. Thus, resources of the servers need to be properly allocated.

### SUMMARY

Some embodiments of this disclosure relate to apparatus, system, computer program product, and method embodiments for implementing resource allocation of SaaS systems.

Some embodiments of this disclosure provide a resource analysis system comprising a memory and at least one processor coupled to the memory. The at least one processor is configured to receive history data of one or more data processes and determine an average central processing unit (CPU) resource and an average memory resource of a data process of the one or more data processes based on the history data. The at least one processor is further configured to determine a resource type of the data process based on the average CPU resource and the average memory resource and transmit a resource type report to a resource record server, wherein the resource type report indicates the resource type of the data process and the data process.

Some embodiments of this disclosure provide a computer-implemented method for a database management system. The method comprises receiving history data of one or more data processes and determining an average CPU resource and an average memory resource of a data process of the one or more data processes based on the history data. The method further comprises determining a resource type of the data process based on the average CPU resource and the average memory resource and transmitting a resource type report to a resource record server, wherein the resource type report indicates the resource type of the data process and the data process.

Some embodiments of this disclosure provide a resource allocation server comprising a memory and at least one processor coupled to the memory. The at least one processor is configured to receive a request for a data process and determine an identification of the data process based on the request. The at least one processor is further configured to retrieve a resource type of the data process based on the identification and assign the data process to a computing server based on the resource type.

This Summary is provided merely for the purposes of illustrating some embodiments to provide an understanding of the subject matter described herein. Accordingly, the above-described features are merely examples and should not be construed to narrow the scope or spirit of the subject matter in this disclosure. Other features, embodiments, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing resource allocation for SaaS systems, according to some embodiments of the disclosure.

FIG. 2 illustrates a block diagram of an example system implementing the resource allocation for SaaS systems, according to some embodiments of the disclosure.

FIG. 3 illustrates an example of a SaaS system supported by job servers, according to some embodiments of the disclosure.

FIG. 4 illustrates an example method of operating the SaaS system supported by job servers, according to some embodiments of the disclosure.

FIG. 5 illustrates an example of illustrates an example of a SaaS system supported by application interference (API) servers, according to embodiments of the disclosure.

FIG. 6 illustrates an example method of operating a resource analysis system, according to embodiments of the disclosure.

FIG. 7 illustrates an example method of operating a resource allocation server, according to embodiments of the disclosure.

FIG. 8 is an example computer system for implementing some embodiments of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments of this disclosure include apparatus, system, computer program product, and method embodiments for implementing resource allocation for SaaS systems.

In some embodiments, cloud computing services, such as SaaS, provides software applications over the Internet. For example, a user device can send tasks to one or more computing servers to perform the tasks. The tasks can include various data processes, such as computer program jobs and data queries. To complete the various data processes, the user device can send the tasks to computing servers of different types. For example, the computing servers can include application programming interface (API) servers, job servers, user interface (UI) servers, media servers, and so on. When the user device is scheduled to perform computer program jobs, the user device can send the computer program jobs to one or more job servers. Similarly, when the user device is scheduled to perform data queries, the user device can send the data queries to one or more API servers.

In some embodiments, the computing servers of each type may have various configuration types. For example, the configuration types can include at least a central processing unit (CPU) intensive type, a memory intensive type, and a balanced type. The CPU intensive type computing servers are configured with high performance CPUs and average memory components. The memory intensive type computing servers are configured with average CPUs and large memory components. The balanced computing servers are configured with average CPUs and average memory components. In some embodiments, the high performance CPUs provide higher than average computing power. The large memory components provide higher than average memory capacity. Similarly, data processes of each type may have various resource types. For example, the resource types can include at least a CPU intensive type, a memory intensive type, and a balanced type. In some embodiments, the CPU intensive type data processes require higher than average CPU computation power and average memory cost. The memory intensive type data processes require average CPU computation power and higher than average memory cost. The balanced type data processes require average CPU computation power and average memory cost.

In some embodiments, it is desirable to send the data processes to computing servers of a suitable configuration type. For example, the user device can send a data process of the CPU intensive type to a CPU intensive computing server. The user device can also send a data process of the memory intensive type to a memory intensive computing server. Finally, the user device can send a data process of the balanced type to a balanced computing server. In some embodiments, sending a data process to a computing server of an unsuitable configuration type can result in wasting resources. For example, if the user device sends a data process of the CPU intensive type to a memory intensive computing server, the data process may use a small portion of memory of the memory intensive computing server and an unused portion of the memory resources are wasted.

In some embodiments, a resource analysis system can determine a resource type of a data process so that the data process is sent to a suitable computing server. For example, the resource analysis system can retrieve history data that indicate resource costs of the data process in the past. In some embodiments, the data process can be executed repeatedly and history data include information of prior executions. Specifically, the history data can indicate a CPU time cost of the data process when executed within a predetermined period of time, such as an hour. The history data can also indicate a memory cost of the data process when executed within the predetermined period of time. In such a case, the resource analysis system can calculate an average CPU resource and an average memory resource of the data process and determine the resource type of the data process based on the average CPU resource and the average memory resource. The resource analysis system can notify the resource type of the data process to a resource allocation server that assigns the data process to a suitable computing server.

In some embodiments, the user device may send data processes to computing servers via the resource allocation server. For example, the user device can send the data processes to the resource allocation server. The resource allocation server can retrieve resource types of the data processes from the resource analysis system directly or indirectly via a resource record server. The resource allocation server can then assign the data processes to the computing servers. In some embodiments, the resource allocation server can assign the data processes by sending the data processes to the computing servers. For example, the resource allocation server can determine that a set of data processes is CPU intensive and thus send the set of data processes to CPU intensive computing servers. In other embodiments, the resource allocation server can assign the data processes by transmitting and/or storing the data processes and their respective resource types in a data process queue. The computing servers can then pull the data processes from the data process queue based on their respective resource types. For example, CPU intensive computing servers can pull data processes that are CPU intensive from the data process queue.

In summary, the resource analysis system can label the data processes with their respective resource types and the resource allocation server can assign the data processes to the computing servers based on their respective resource types.

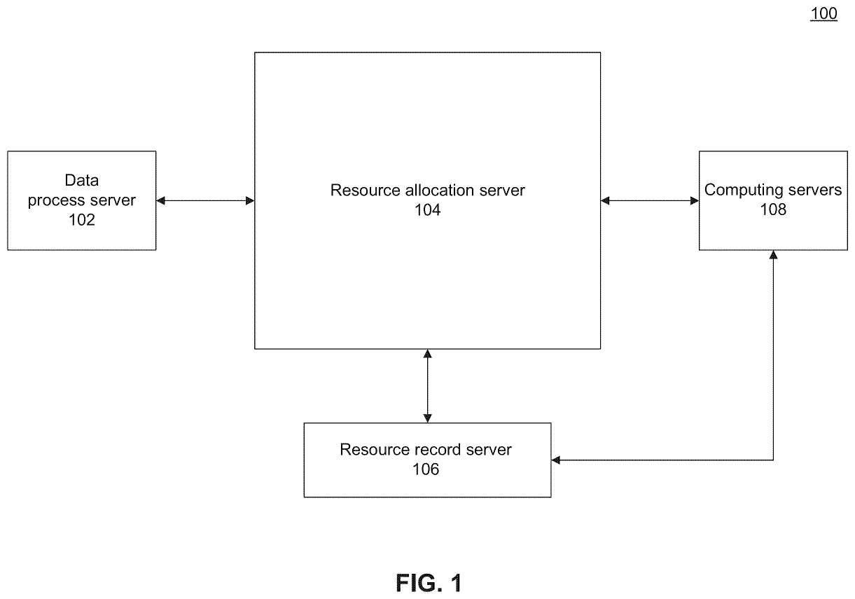

FIG. 1 illustrates an example system implementing resource allocation for SaaS systems, according to some embodiments of the disclosure. The example system 100 is provided for the purpose of illustration only and does not limit the disclosed embodiments. The example system 100 may include, but is not limited to, a data process server 102, a resource allocation server 104, a resource record server 106, and one or more computing servers 108. In some embodiments, the data process server 102, the resource allocation server 104, the resource record server 106, and the one or more computing servers 108 may include, but is not limited to, computer systems, servers, cloud systems, cloud servers, laptops, desktops, personal computers, databases, user equipment, and the like. In some embodiments, the data process server 102 and the resource record server 106 can be integrated into a physical device so that functions of the data process server 102 and the resource record server 106 can be performed by the physical device. In some embodiments, the data process server 102 can be a database connected to the resource allocation server 104.

In some embodiments, the data process server 102 receives or generates data processes to be executed. The data processes may include computer program jobs, data queries, and/or other data processes. The data process server 102 may deliver the data processes to the resource allocation server 104. For example, the data process server 102 may transmit the data processes to the resource allocation server 104 when the data process server 102 receives or generates the data processes. For another example, the resource allocation server 104 may pull the data processes from the data process server 102. In some embodiments, the resource allocation server 104 may indicate data processes to be pulled. For example, the resource allocation server 104 can transmit a retrieving request to the data process server 102. The retrieving request can indicate one or more data processes. For another example, the retrieving request can indicate characteristics of data processes. Specifically, the retrieving request can indicate the data processes to be executed within a time period, such as 10 seconds.

In some embodiments, the resource allocation server 104 may assign the data processes received from the data process server 102 to the one or more computing servers 108. The resource allocation server 104 can retrieve resource types of the data processes. For example, the resource allocation server 104 may generate a resource type request that indicates identifications (IDs) of the data processes. Upon receiving the resource type request, the resource record server 106 may look up resource types of the data processes based on the IDs. The resource record server 106 may then generate a resource type report indicating the resource types and transmit the resource type report to the resource allocation server 104.

In some embodiments, the data processes may include a first data process that is CPU intensive, a second data process that is memory intensive, and a third data process that is balanced. The resource types indicated by the resource type report may correspond to these resource types. In such a case, the resource allocation server 104 can assign the first data process to a first computing server of the one or more computing servers 108, wherein the first computing server is CPU intensive. The resource allocation server 104 may also assign the second data process to a second computing server of the one or more computing servers 108, wherein the second computing server is memory intensive. Finally, the resource allocation server 104 may assign the third data process to a third computing server of the one or more computing servers 108, wherein the third computing server is balanced. The first, the second, and the third computing servers then execute the first, the second, and the third data processes respectively.

In some embodiments, the one or more computing servers 108 may save resource usage information after executing the data processes. For example, the first computing server can save a CPU cost and a memory cost of executing the first data process. In some embodiments, the one or more computing server 108 may transmit the resource usage information to the resource record server 106. For example, the first computing server can also transmit the saved CPU cost and memory cost to the resource record server 106. In some embodiments, the one or more computing server 108 may transmit to the resource record server 106 indirectly. For example, the first computing server can transmit the saved CPU cost and memory cost to a resource analysis system (not shown here). The resource analysis system can determine a resource type of the first data process based on the usage information. The resource analysis system can then transmit the resource type to the resource record server 106.

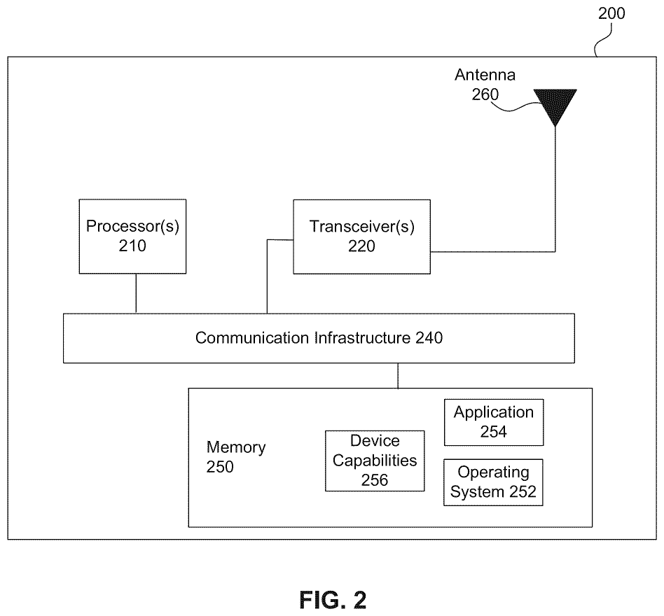

FIG. 2 illustrates a block diagram of an example system implementing the resource allocation for SaaS systems, according to some embodiments of the disclosure. The electronic device 200 may be any of the electronic devices (e.g., the data process server 102, the resource allocation server 104, the resource record server 106, and the one or more computing servers 108, or a combination thereof of FIG. 1) of the system 100. The electronic device 200 includes a processor 210, one or more transceivers 220, a communication infrastructure 240, a memory 250, an operating system 252, an application 254, device capabilities 256, and antenna 260. Illustrated systems are provided as exemplary parts of electronic device 200, and electronic device 200 may include other circuit(s) and subsystem(s). Also, although the systems of electronic device 200 are illustrated as separate components, the embodiments of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. The application 254 may include functions such as, but not limited to, radio streaming, video streaming, remote control, applications used in enterprise resource planning (ERP) and/or other user functions. In some embodiments, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the system 100 to implement mechanisms for the resource allocation for SaaS systems, as described herein. Alternatively, or additionally, the processor 210 can be “hard coded” to implement mechanisms for the resource allocation for SaaS systems, as described herein.

The one or more transceivers 220 transmit and receive communications signals support mechanisms for the resource allocation for SaaS systems. Additionally, the one or more transceivers 220 transmit and receive communications signals that support mechanisms for measuring communication link(s), generating and transmitting system information and data, and receiving the system information and data. According to some embodiments, the one or more transceivers 220 may be coupled to the antenna 260 to wirelessly transmit and receive the communication signals. The antenna 260 may include one or more antennas that may be the same or different types and can form one or more antenna ports. In some embodiments, the antenna 260 can be replaced or used in combination with wired communication interferences, such as Ethernet, Universal Serial Bus (USB), serial port, serial advanced technology attachment (SATA), and fiber optic interferences. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some embodiments of this disclosure, the one or more transceivers 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver. Additionally, the one or more the transceivers 220 may include one or more circuits (including a cellular transceiver) for connecting to and communicating on cellular networks.

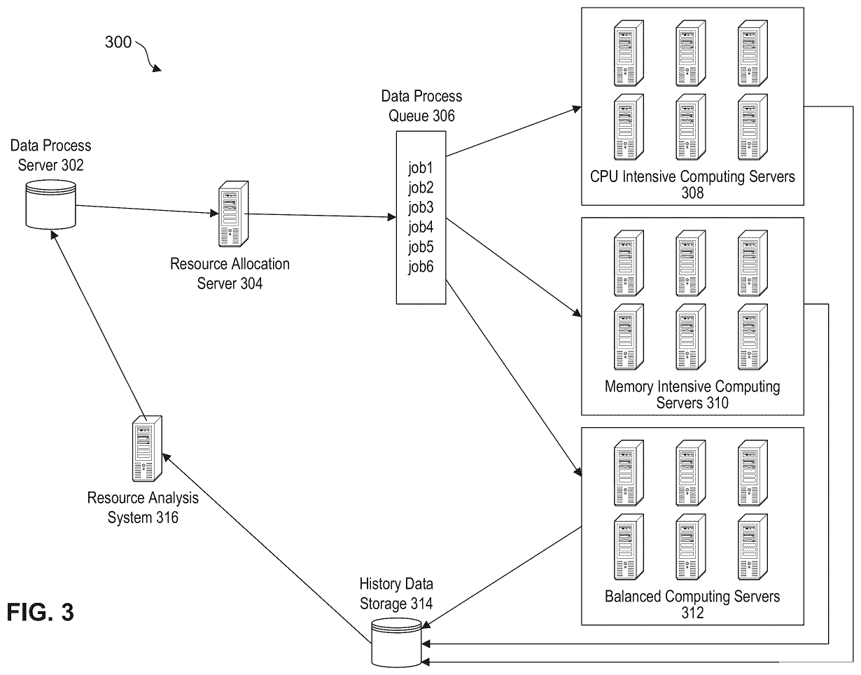

As discussed in more detail below with respect to FIGS. 3-8, processor 210 may implement different mechanisms for the resource allocation for SaaS systems as discussed with respect to the system 100 of FIG. 1.

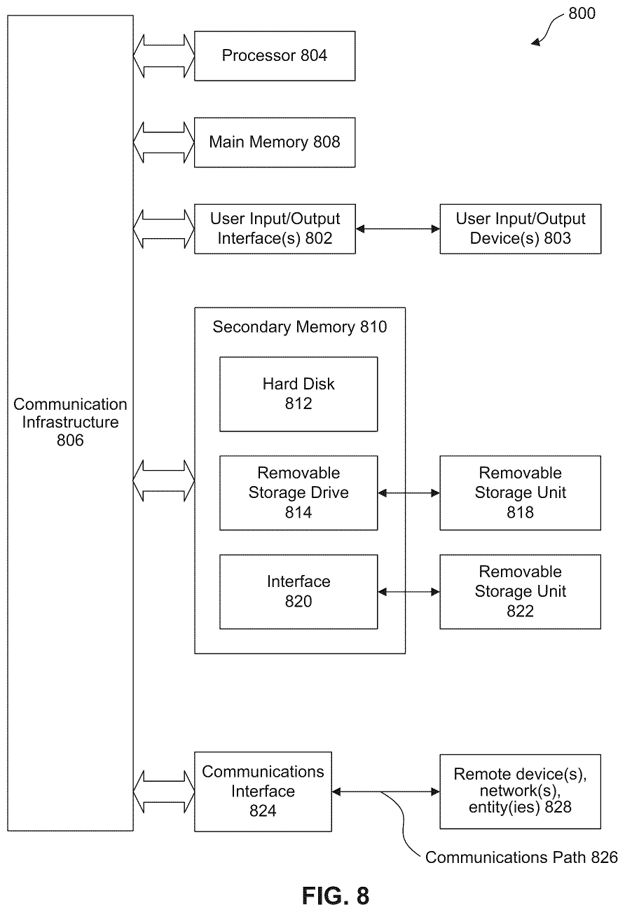

FIG. 3 illustrates an example 300 of a SaaS system supported by job servers, according to some embodiments of the disclosure. As a convenience and not a limitation, FIG. 3 may be described with regard to elements of FIGS. 1, 2, and 8. The example 300 may represent the operation of devices (e.g., the data process server 102, the resource allocation server 104, the resource record server 106, and the one or more computing servers 108, or a combination thereof of FIG. 1) implementing the resource allocation for SaaS systems. The example 300 may also be performed by computer system 800 of FIG. 8. But the example 300 is not limited to the specific embodiments depicted in those figures and other systems may be used to perform the method, as will be understood by those skilled in the art. It is to be appreciated that not all operations may be needed, and the operations may not be performed in the same order as shown in FIG. 3.

In some embodiments, a data process server 302 may store one or more computer program jobs. For example, a computer program job may be performed by a computer or processors of the computer. The computer or the processor of the computer can perform one or more operations based on a set of instructions corresponding to the computer program job. In some embodiments, a computer program job may include various types. For example, the computer program job may include calculations, data processing, word processing, graphic processing, media processing, communication, database management, and so on. In some embodiments, the data process server 302 may also store resource types of the one or more computer program jobs. For example, a computer program job can be CPU intensive, memory intensive, or balanced. In some embodiments, the data process server 302 may store the one or more computer program jobs in a table, such as Table 1 shown below. For example, as shown below, a first computer program job may have a Job ID 1 and is CPU intensive. A second computer program job may have a job ID 2 and is memory intensive. A third computer program job may have a job ID 3 and is balanced. In some embodiments, job IDs are saved as numerical values used to identify computer program jobs. Resource types, such as CPU intensive, memory intensive, and balanced may be saved as strings or code be encoded (e.g., CPU intensive=1; memory intensive=2; balanced=3). In addition, computer program jobs also include a default type. Here, the default resource type is balanced. Thus, when the resource type of a computer program job is not defined based on prior executions, the resource type is assumed to be balanced. For example, a fourth computer program job may have a job ID 4 and its resource type is not yet defined. In such a case, the resource type of the fourth computer program job is set to be balanced. It is worth noting that the resource type of the third computer program job is also set to be balanced. However, the resource type of the third computer program job may be determined based on historic data. For example, the third computer program job may have been executed one or more times and was determined to be balanced based on the prior executions. In some embodiments, the data process server 302 transmits the computer program jobs and their corresponding resource types using a table, such Table 1.

TABLE 1

| Job ID | Resource type |
|---|---|
| Job ID 1 | CPU intensive |
| Job ID 2 | Memory Intensive |
| Job ID 3 | Balanced (Historic) |
| Job ID 4 | Balanced (Default) |

In some embodiments, the data process server 302 may transmit the table to the resource allocation server 304 when computer program jobs are saved in the data process server 302. In other embodiments, the resource allocation server 304 may request the computer program jobs from the data process server 302. For example, the resource allocation server 304 can generate and transmit a retrieving request to the data process server 302. The retrieving request may indicate one or more computer program jobs. For example, the retrieving request may include job IDs of the one or more computer program jobs. For another example, the retrieving request may indicate a time period, such as 10 seconds. The one or more computer program jobs may be scheduled to be executed within 10 seconds. In either case, the data process server 302 may generate a table, similar to Table 1, which includes the one or more computer program jobs with their respective resource types and default resource types. The data process server 302 can then transmit the table to the resource allocation server 304.

In some embodiments, the resource allocation server 304 may assign the one or more computer program jobs to computing servers via a data process queue 306. For example, the resource allocation server 304 transmits the one or more computer program jobs to the data process queue 306. The data process queue 306 may be a database that can be accessed by computing servers, such as one or more CPU intensive computing servers 308, one or more memory intensive computing servers 310, and one or more balanced computing server 312. The data process queue 306 may save the one or more computer program jobs as a table similar to Table 1.

In some embodiments, computing servers, such as the one or more CPU intensive computing servers 308, the one or more memory intensive computing servers 310, and the one or more balanced computing server 312, may pull computer processes from the data process queue 306. For example, a CPU intensive computing server of the one or more CPU intensive computing servers 308 can check the data process queue 306 and determine that a next computer program job is a CPU intensive computer program job. In such a case, the CPU intensive computing server can retrieve the CPU intensive computer program job from the data process queue 306 and execute it. Similarly, a memory intensive computing server of the one or more memory intensive computing server 310 can check and determine that a next computer program job is a memory intensive computer program job and thus retrieve the memory intensive computer program job for execution. In some embodiments, a computer program job may not have a resource type that is determined based on prior executions. For example, the resource type of a computer program job may not be determined yet because the computer program job may not have been executed yet. For another example, the resource type was determined a long time ago, such as 30 days ago, and may have not been executed within a period of time. In such a case, the resource type of the computer program job may be expired. In either case, the computing servers may assume that the computing program job is the default resource type. For example, the CPU intensive computing server and the memory intensive computing server may check the computer program job and determine that it has no assigned resource type and thus a balanced type. In such a case, the CPU intensive computing server and the memory intensive computing server may determine not to retrieve the computer program job because they assume that the resource type is balanced because the default resource type is balanced. In contrast, a balanced computing server may also check and determine that the computer program job has no assigned resource type. In such a case, the balanced computing server may retrieve and execute the computer program job.

In some embodiments, the computing servers can execute a computer program job based on its job ID. For example, the computer program job may be a calculation task and the job ID can be pre-assigned to the computer program job. In such a case, after retrieving the job ID from the data process queue 306, a computing server may look up the calculation task based on the job ID and perform the calculation task.

In some embodiments, computing servers may save resource usage information of the computer program jobs. For example, the computing servers, such as the one or more CPU intensive computing servers 308, the one or more memory intensive computing servers 310, and the one or more balanced computing servers 312, can save a CPU cost and a memory cost after executing a computer program job. In some embodiments, the computing servers can record a time length that the computer program job occupied the CPU and a size of memory used to store data when executing the computer program job. For example, the computer program job may have occupied the CPU for 90000 ms and used 500 Mb memory when executed. The computing server can then transmit the usage information of the computer program job to a history data storage 314.

In some embodiments, the history data storage 314 may save usage information of computer program jobs as history data when the computer program jobs were executed. For example, a computer program job may be executed ten times. Each time a computing server executed the computer program job, the computing server may transmit usage information of that execution to the history data storage 314. In such a case, the history data storage 314 may store usage information of the computer program job for ten executions. In some embodiments, the history data storage 314 may keep usage information within an expiration period, such as 10 minutes, and may discard expired usage information. For example, out of ten executions of the computer program job, six executions are within the expiration period. In other words, six executions were performed within 10 minutes and four executions were performed more than 10 minutes ago. In such a case, the history data storage 314 may keep the six executions and discard the four executions that are expired.

In some embodiments, a resource analysis system 316 may determine and/or update resource types of computer program jobs based on the history data. For example, the resource analysis system 316 can retrieve the history data from the history data storage 314. In some embodiments, for a computer program job, the resource analysis system can first determine an average CPU resource and an average memory resource of the computer program job. For example, the history data may include six executions of the computer program job. In such a case, the resource analysis system 316 can determine the average CPU resource by taking an average of CPU costs of the six executions. Similarly, the resource analysis system 316 can determine the average memory resource by taking an average of memory costs of the six executions. Specifically, the resource analysis system 316 can determine the average CPU resource and the average memory resource based following equations:

$$\overline{C P U} = \frac{1}{N} {\sum }_{k = 1}^{N} C P {U}_{k} \qquad ( 1 )$$

$$\overline{Memory} = - \frac{1}{N} {\sum }_{k = 1}^{N} {Memory}_{k} \qquad ( 2 )$$

where C̅P̅U̅ is the average CPU resource and M̅e̅m̅o̅r̅y̅ is the average memory resource. N is a number of executions stored in the history data. For example, when usage information of six executions of the computer program job is included in the history data, N=6. In some embodiments, N corresponds to an expiration period. As discussed above, the history data storage 314 may discard usage information that is beyond the expiration period. Here, when the six executions are within the expiration period, six executions are included in the history data and thus N=6.

In some embodiments, the resource analysis system 316 can further determine a base CPU resource and a base memory resource. For example, the resource analysis system 316 can calculate the base CPU resource by averaging CPU costs of executions of computer program jobs included in the history data. For example, the history data may include usage information of six executions of a first computer program job and ten executions of a second computer program job. Thus, a total of sixteen executions are included in the history data. The resource analysis system 316 can calculate the base CPU resource by averaging CPU costs of the sixteen executions of the first and the second computer program jobs. Similarly, the resource analysis system 316 can also calculate the base memory resource by averaging memory costs of the sixteen executions of the first and the second computer program jobs.

In some embodiments, the resource analysis system 316 can determine a resource type score based on the average CPU resource, the average memory resource, the base CPU resource, and the base memory resource. For example, the resource analysis system 316 can determine the resource type score as following:

$$Score = {W}_{1} * ( \overline{C P U} - C P {U}_{base} ) - {W}_{2} * ( \overline{Memory} - {Memory}_{base} ) \qquad ( 3 )$$

where W₁ and W₂ are weighting factors. In some embodiments, W₁ and W₂ are predetermined values. For example, W₁ can be

$$\frac{1}{500000 second}$$

### and W₂ can be

$$\frac{1}{500000 bytes} .$$

In other embodiments, W₁ and W₂ correspond to the base CPU resource and the base memory resource. For example, W₁ can be

$$\frac{1}{C P {U}_{base}}$$

### and W₂ can be

$$\frac{1}{{Memory}_{base}} .$$

In some embodiments, the resource analysis system 316 can determine a resource type of the computer program job based on the resource type score. For example, the resource analysis system 316 may determine that the computer program job is CPU intensive if the resource type score is greater than 1. The resource analysis system 316 may determine that the computer program job is memory intensive if the resource type score is smaller than −1. Finally, the resource analysis system 316 may determine that the computer program job is balanced when the resource type score is smaller than or equal to 1 and when the resource type score is greater than or equal to −1. For example, the resource analysis system 316 can determine the resource as following:

$$ResourceType = \{ \begin{matrix}C P U - intensive , & if Score > 1 \\ memory - intensive , & if Score < - 1 \\ balance , & if - 1 \leq Score \leq 1\end{matrix} . \qquad ( 4 )$$

In some embodiments, the resource analysis system 316 may transmit the determined resource types of the computer program jobs to the data process server 302. The resource analysis system 316 can periodically update the resource types and transmit the resource types to the data process server 302.

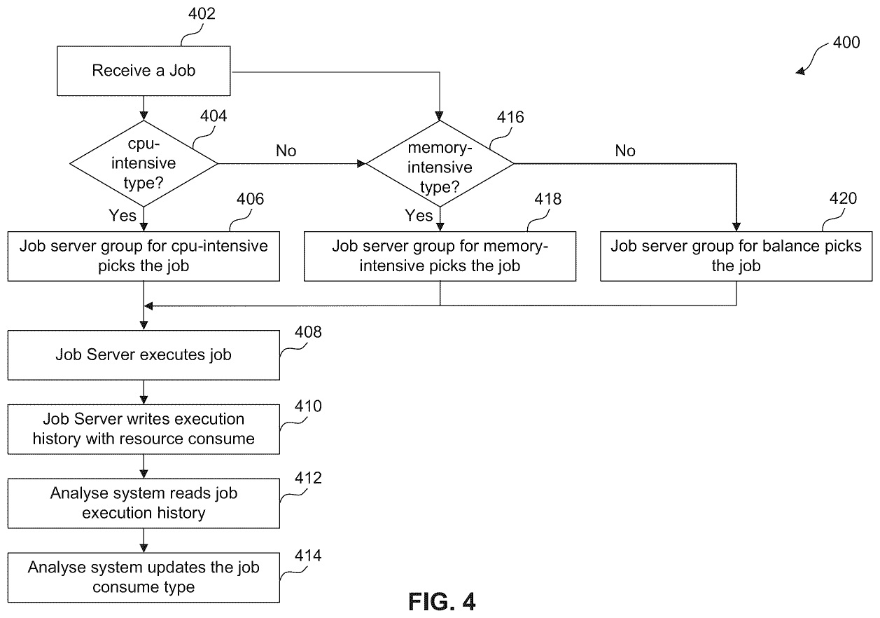

FIG. 4 illustrates an example method 400 of operating the SaaS system supported by job servers, according to some embodiments of the disclosure. As a convenience and not a limitation, FIG. 4 may be described with regard to elements of FIGS. 1, 2, and 8. The example method 400 may represent the operation of devices (e.g., the data process server 102, the resource allocation server 104, the resource record server 106, and the one or more computing servers 108, or a combination thereof of FIG. 1) implementing the resource allocation for SaaS systems. The example method 400 may also be performed by computer system 800 of FIG. 8. But the example method 400 is not limited to the specific embodiments depicted in those figures and other systems may be used to perform the method, as will be understood by those skilled in the art. It is to be appreciated that not all operations may be needed, and the operations may not be performed in the same order as shown in FIG. 4.

At 402, a resource allocation server, such as the resource allocation server 304 in FIG. 3, receives a computer program job. In some embodiments, a data process server, such as the data process server 302, may transmit the computer program job to the resource allocation server. In other embodiments, the resource allocation server may retrieve the computer program job from the data process server. In some embodiments, the resource allocation server 304 may also receive a resource type of the computer program job when receiving the computer program job from the data process server. The resource allocation server can then store the computer program job and its resource type in a data process queue, such as the data process queue 306 in FIG. 3.

At 404, a CPU intensive computing server may check the data process queue and determine whether the computer program job is CPU intensive. If the resource type of the computer program job is CPU intensive, the control moves to 406.

At 406, the CPU intensive computing server retrieves the computer program job from the data process queue. As discussed above, the data process queue may also include a job ID of the computer program job.

At 408, the appropriate server group, since control came from 406, the appropriate server group is the CPU intensive computing server may execute the computer program job. In some embodiments, the CPU intensive computing server may execute the computer program job using the job ID.

At 410, the appropriate server group, such as the CPU intensive computing server, may save usage information of the computer program job in a history data storage, such as the history data storage 314 in FIG. 3. For example, the usage information may include a CPU cost and a memory cost of executing the computer program job.

At 412, a resource analysis system, such as the resource analysis system 316 in FIG. 3, may read the usage information of the computer program job and usage information of other computer program jobs stored in the history data storage. At 414, the resource analysis system may determine a resource type of the computer program job and save the resource type in a data process server, such as the data process server 302. When the data process server includes a resource type that was previously stored, the data process server may replace the previous resource type using the resource type determined by the resource analysis system at 412.

Referring back to 404, if the computer program job is not CPU intensive, the CPU intensive computing server may ignore the computer program job. The control moves to 416.

At 416, a memory intensive computing server determines whether the computer program job is memory intensive. If the memory intensive computing server determines that the computer program job is memory intensive, the control moves to 418.

At 418, the memory intensive computing server retrieves the computer program job from the data process queue. As discussed above, the data process queue may also include a job ID of the computer program job. Moving from 418 to 408, the memory intensive computing server may execute the computer program job and save the usage information of the computer program job instead of the CPU intensive computing server.

Referring back to 416, if the memory intensive computing server determines that the computer program job is not memory intensive, the memory intensive computing server may ignore the computer program job. The control moves to 420.

At 420, a balanced computing server retrieves the computer program job from the data process queue. As discussed above, the data process queue may also include a job ID of the computer program job. Moving from 420 to 408, the balanced intensive computing server may execute the computer program job and save the usage information of the computer program job.

It should be noted that alternative implementations of FIG. 4 are within the scope of this invention. For example, instead of having two separate decision points of 404 and 416, a single decision point may be implemented that assigns the received job a type of CPU intensive, memory intensive or balanced where control moves from 406, 418 or 420 depending on the type assignment.

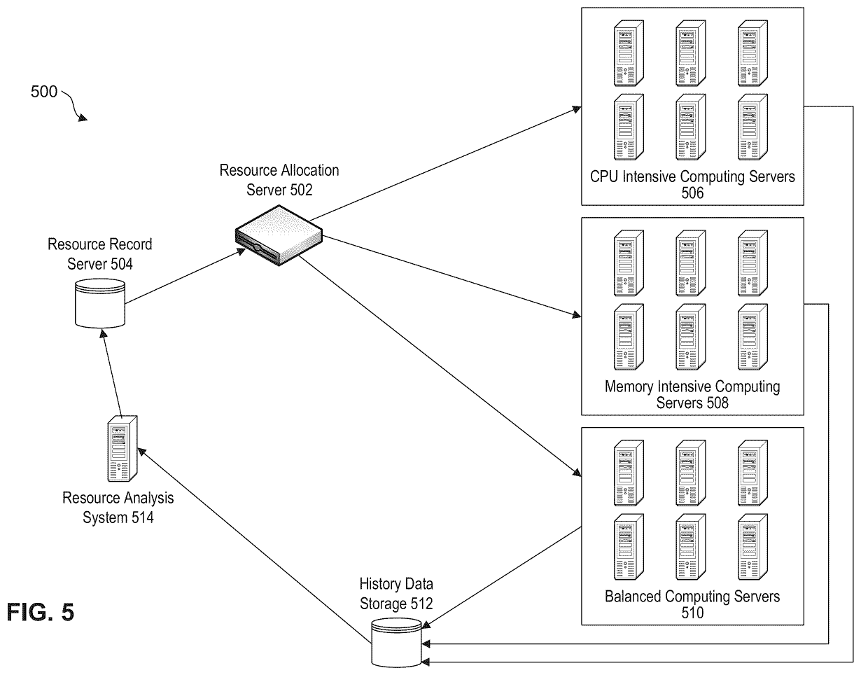

FIG. 5 illustrates an example 500 of a SaaS system supported by application interference (API) servers. As a convenience and not a limitation, FIG. 5 may be described with regard to elements of FIGS. 1, 2, and 8. The example 500 may represent the operation of devices (e.g., the data process server 102, the resource allocation server 104, the resource record server 106, and the one or more computing servers 108, or a combination thereof of FIG. 1) implementing the resource allocation for SaaS systems. The example 500 may also be performed by computer system 800 of FIG. 8. But the example 500 is not limited to the specific embodiments depicted in those figures and other systems may be used to perform the method, as will be understood by those skilled in the art. It is to be appreciated that not all operations may be needed, and the operations may not be performed in the same order as shown in FIG. 5.

In some embodiments, a resource allocation server 502 may receive a data query from other devices, such as user devices. For example, the resource allocation server 502 may receive a request for a data query. The request may include an ID of the data query. The ID may include a uniform resource identifier (URI) and a request method of the data query. In some embodiments, the request method may include GET, POST, PUT, PATCH, DELETE, and others. The data query can be identified using both the URI and the request method.

In some embodiments, the resource allocation server 502 may retrieve a resource type of the data query from the resource record server 504. For example, the resource allocation server 502 can generate and transmit a resource type request to the resource record server 504. The resource type request may include the ID of the data query, which includes both the URI and the request method. The resource record server 504 can look up the data query based on the ID of the data query and determine a resource type. The resource record server 504 can then transmit the resource type to the resource allocation server 502. In some embodiments, the resource record server 504 can store resource types of data queries in a table, such as Table 2 shown below. Table 2 includes resource types of three data queries. If the data query corresponds to URI 1 and a PATCH method, the resource record server 504 may report CPU intensive type to the resource allocation server 502. If the data query corresponds to the URI 1, but a GET method, the data query is memory intensive. In other words, data queries with a same URI but different request methods may have different resource types. Finally, if the data query corresponds to URI 2 and the PATCH method, the data query is balanced. Thus, data queries with a same request method but different URIs may have different resource types. In some embodiments, a data query may have not been assigned a resource type based on prior executions. For example, a data query may corresponds to the URI 2 and a GET method. The data query may have not been executed and thus its resource type is not yet defined based on prior executions. In such a case, the resource type of the data query is set to be balanced. It is worth noting that the resource type of the data query corresponding to the URI 2 and the PATCH method is also set to be balanced. However, the resource type of the data query corresponding to the URI 2 and the PATCH method may be determined based on historic data. For example, the data query corresponding to the URI 2 and the PATCH method may have been executed one or more times and was determined to be balanced based on the prior executions

TABLE 2

| URI | Request Method | Resource type |
|---|---|---|
| URI 1 | PATCH | CPU intensive |
| URI 1 | GET | Memory Intensive |
| URI 2 | PATCH | Balanced (Historic) |
| URI 2 | GET | Balanced (Default) |

In some embodiments, the resource allocation server 502 may assign the data query to a computing server based on the resource type. For example, if the resource type is CPU intensive, the resource allocation server 502 can send the data query to a CPU intensive computing server of one or more CPU intensive computing servers 506 for execution. If the resource type is memory intensive, the resource allocation server 502 can send the data query to a memory intensive computing server of one or more memory intensive computing servers 508 for execution. If the resource type is balanced, the resource allocation server 502 can send the data query to a balanced computing server of one or more balanced computing servers 510 for execution.

In some embodiments, similar to discussion above in FIG. 3, computing servers of the one or more computing servers 506, the one or more computing servers 508, and the one or more balanced computing server 510 may report usage information of data queries to a history data storage 512. In addition, a resource analysis system 514 may determine resource types of the data queries based on the usage information retrieve from the history data storage 512, as discussed in details in FIG. 3. Finally, the resource analysis system 514 may transmits the resource types of the data queries to the resource record server 504.

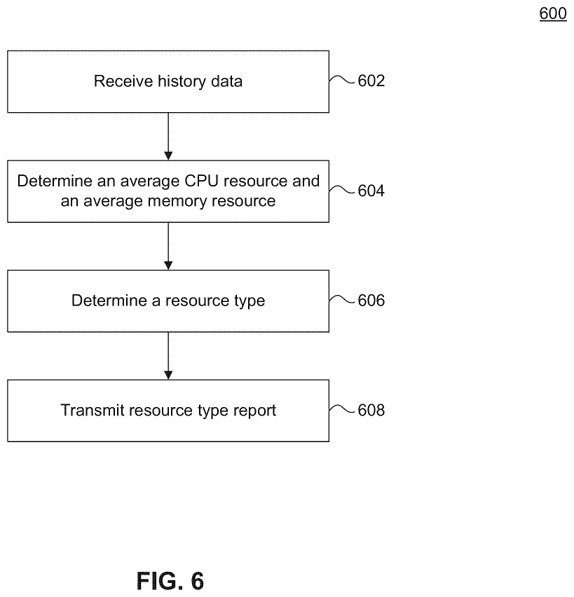

FIG. 6 illustrates an example method 600 of operating a resource analysis system, according to embodiments of the disclosure. As a convenience and not a limitation, FIG. 6 may be described with regard to elements of FIGS. 1, 2, and 8. The example method 600 may represent the operation of devices (e.g., the data process server 102, the resource allocation server 104, the resource record server 106, and the one or more computing servers 108, or a combination thereof of FIG. 1) implementing the resource allocation for SaaS systems. The example method 600 may also be performed by computer system 800 of FIG. 8. But the example method 600 is not limited to the specific embodiments depicted in those figures and other systems may be used to perform the method, as will be understood by those skilled in the art. It is to be appreciated that not all operations may be needed, and the operations may not be performed in the same order as shown in FIG. 6.

At 602, a resource analysis system receives history data of one or more data processes. The history data are within a predetermined period of time.

At 604, the resource analysis system determines an average CPU resource and an average memory resource of a data process of the one or more data processes based on the history data. In some embodiments, the data process includes a computer program job corresponding to a job ID. In other embodiments, the data process includes a data query corresponding to a URI and a request method.

At 606, the resource analysis system determines a resource type of the data query based on the average CPU resource and the average memory resource. In some embodiments, in addition to the average CPU resource and the average memory resource, the resource analysis system determines the resource type based on a base CPU resource and a base memory resource.

At 608, the resource analysis system transmits the resource type to a resource record server. For example, the resource analysis system can transmit a resource type report to the resource record server. The resource type report indicates the resource type of the data process and the data process.

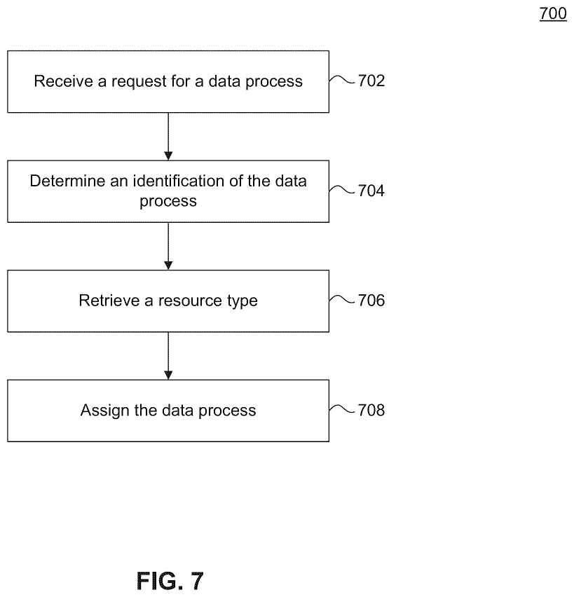

FIG. 7 illustrates an example method 700 of operating a resource allocation server, according to embodiments of the disclosure. As a convenience and not a limitation, FIG. 7 may be described with regard to elements of FIGS. 1, 2, and 8. The example method 700 may represent the operation of devices (e.g., the data process server 102, the resource allocation server 104, the resource record server 106, and the one or more computing servers 108, or a combination thereof of FIG. 1) implementing the resource allocation for SaaS systems. The example method 700 may also be performed by computer system 800 of FIG. 8. But the example method 700 is not limited to the specific embodiments depicted in those figures and other systems may be used to perform the method, as will be understood by those skilled in the art. It is to be appreciated that not all operations may be needed, and the operations may not be performed in the same order as shown in FIG. 7.

At 702, a resource allocation server receives a request for a data process. In some embodiments, the data process includes a computer program job corresponding to a job ID. In other embodiments, the data process includes a data query corresponding to a URI and a request method.

At 704, the resource allocation server determines an ID of the data process based on the request. In some embodiments, the request may indicate or include the ID. For example, if the data process is a computer program job, the request may indicate or include the job ID of the computer program job. If the data process is a data query, the request may indicate or include the URI and the request method of the data query.

At 706, the resource allocation server retrieves a resource type of the data process based on the ID. The resource type can be CPU intensive, memory intensive, or balanced.

At 708, the resource allocation server can assign the data process to a computing server based on the resource type. For example, if the data process is CPU intensive, the resource allocation server can assign the data process to a CPU intensive computing server.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A resource analysis system, comprising:
a memory; and
at least one processor coupled to the memory and configured to:
receive history data of one or more data processes;
determine an average central processing unit (CPU) resource and an average memory resource of a data process of the one or more data processes based on the history data;
determine a resource type of the data process based on the average CPU resource and the average memory resource; and
transmit a resource type report to a resource record server, wherein the resource type report indicates the resource type of the data process and the data process.

2. The resource analysis system of claim 1, wherein the history data are within a predetermined period of time.

3. The resource analysis system of claim 1,
wherein the data process includes a computer program job, and
wherein the resource type report indicates the computer program job using a job identification (ID).

4. The resource analysis system of claim 1, wherein the data process includes a data query.

5. The resource analysis system of claim 4, wherein the resource type report indicates the data query using a uniform resource identifier (URI) and a request method.

6. The resource analysis system of claim 1, wherein to determine the resource type of the data process, the at least one processor is further configured to:
determine a base CPU resource and a base memory resource; and
determine the resource type of the data process based on the base CPU resource and the base memory resource.

7. The resource analysis system of claim 6,
wherein the base CPU resource corresponds to CPU costs of the one or more data processes, and
wherein the base memory resource corresponds to memory costs of the one or more data processes.

8. A computer-implemented method for a resource analysis system, comprising:
receiving history data of one or more data processes;
determining an average central processing unit (CPU) resource and an average memory resource of a data process of the one or more data processes based on the history data;
determining a resource type of the data process based on the average CPU resource and the average memory resource; and
transmitting a resource type report to a resource record server, wherein the resource type report indicates the resource type of the data process and the data process.

9. The computer-implemented method of claim 8, wherein the history data are within a predetermined period of time.

10. The computer-implemented method of claim 8,
wherein the data process includes a computer program job, and
wherein the resource type report indicates the computer program job using a job identification (ID).

11. The computer-implemented method of claim 8,
wherein the data process includes a data query, and
wherein the resource type report indicates the data query using a uniform resource identifier (URI) and a request method.

12. The computer-implemented method of claim 8, wherein determining the resource type of the data process further comprises:
determining a base CPU resource and a base memory resource; and
determining the resource type of the data process based on the base CPU resource and the base memory resource.

13. The computer-implemented method of claim 8,
wherein the base CPU resource corresponds to CPU costs of the one or more data processes, and
wherein the base memory resource corresponds to memory costs of the one or more data processes.

14. A resource allocation server, comprising:
a memory; and
at least one processor coupled to the memory and configured to:
receive a request for a data process;
determine an identification of the data process based on the request;
retrieve a resource type of the data process based on the identification; and
assign the data process to a computing server based on the resource type.

15. The resource allocation server of claim 14, wherein to retrieve the resource type of the data process, the at least one processor is further configured to:
generate a resource type request that indicates the identification;
transmit the resource type request to a resource record server; and
receive the resource type from the resource record server.

16. The resource allocation server of claim 14,
wherein the data process includes a data query, and
wherein the identification includes a uniform resource identifier (URI) and a request method.

17. The resource allocation server of claim 14, wherein the resource type includes a central processing unit (CPU) intense type, a memory intense type, and a balanced type.

18. The resource allocation server of claim 14, wherein the at least one processor is further configured to:
determine that the resource type of the data process is not assigned; and
determine that the resource type is a balanced type.

19. The resource allocation server of claim 14, wherein to assign the data process to the computing server, the at least one processor is further configured to:
determine that the computing server corresponds to the resource type of the data process; and
transmit the data process to the computing server.

20. The resource allocation server of claim 14, wherein to assign the data process to the computing server, the at least one processor is further configured to:
transit the resource type and the data process to a data process queue,
wherein the computing server pulls the data process based on the resource type from the data process queue, and
wherein the computing server corresponds to the resource type.
